(19) United States
(12) Patent Application Publication
(10) Pub. No.: US 2015/0132008 A1
(43) Pub. Date: May 14, 2015

(54) VIA-LESS MULTI-LAYER INTEGRATED CIRCUIT WITH INTER-LAYER INTERCONNECTION

(71) Applicant: TAIWAN SEMICONDUCTOR MANUFACTURING COMPANY, LTD., Hsinchu (TW)

(72) Inventors: Ying-Hao KUO, Hsinchu City (TW); Kuo-Chung YEE, Taoyuan City (TW)

(73) Assignee: TAIWAN SEMICONDUCTOR MANUFACTURING COMPANY, LTD., Hsinchu (TW)

(21) Appl. No.: 14/076,537

(22) Filed: Nov. 11, 2013

(51) Int. Cl. H04B 10/40; H04B 10/60; H04B 10/50

(52) U.S. Cl. CPC H04B 10/40; H04B 10/501; H04B 10/60
USPC 398/135

(57) ABSTRACT

A multi-layer integrated circuit comprises a light source configured to input source light to a first optical transmitter. The first optical transmitter is configured to modify the source light and to output a first modulated light based on data received from a first circuit to a second optical receiver. The first modulated light indicates a first data set, the second optical receiver is configured to receive the first modulated light and communicate the first data set to a second circuit.

### BACKGROUND

Device manufacturers are continually challenged to deliver value and convenience to consumers by, for example, developing integrated circuits that provide quality performance. The push for faster processing speeds and advanced operational capabilities has led device manufacturers to develop three-dimensional or multi-layer integrated circuits. Multi-layer integrated circuits sometimes comprise processors, analog circuits, and/or memories on various layers or levels that communicate with one another. Multi-layer integrated circuits are often configured to facilitate communication between layers using through silicon vias (TSV) or inter-layer-vias (ILV) and/or micro-bumps.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry various features may not be drawn to scale and are used for illustration purposes only. In fact, the dimensions of the various features in the drawings may be arbitrarily increased or reduced for clarity of discussion. One or more embodiments are illustrated in the accompanying drawings, incorporated by reference herein in their entirety, in which:

FIG. 1 is a diagram of a multi-layer integrated circuit, in accordance with one or more embodiments;

FIG. 2 is a diagram of the first layer of the FIG. 1 multi-layer integrated circuit, in accordance with one or more embodiments;

FIG. 3 is another diagram of the first layer of the FIG. 1 multi-layer integrated circuit, in accordance with one or more embodiments;

FIG. 4 is another diagram of the first layer of the FIG. 1 multi-layer integrated circuit, in accordance with one or more embodiments;

FIG. 5 is another diagram of the first layer of the FIG. 1 multi-layer integrated circuit, in accordance with one or more embodiments;

FIG. 6 is another diagram of the first layer of the FIG. 1 multi-layer integrated circuit, in accordance with one or more embodiments;

FIG. 7 is another diagram of the first layer of the FIG. 1 multi-layer integrated circuit, in accordance with one or more embodiments; and

FIG. 8 is a flow chart of a method of via-less communication in a multi-layer integrated circuit, in accordance with one or more embodiments.

### DETAILED DESCRIPTION

The following disclosure provides many different embodiments, or examples, for implementing different features of the invention. Specific examples of components and arrangements are described below to simplify the present disclosure. These are examples and are not intended to be limiting.

Multi-layer integrated circuits are often configured to facilitate communication between layers using through silicon vias (TSV) or inter-layer-vias (ILV) and/or micro-bumps. TSVs and micro-bumps often experience signal interference due to the coupling effect and ILVs often have very tight tolerances which reduce production efficiency and introduces the opportunity for errors or defects in production and performance of an integrated circuit having ILVs.

Accordingly, a via-less approach for inter-layer interconnection and communication eliminates the need for TSVs, ILVs, micro-bumps, and the like according to one or more embodiments. A via-less approach for inter-layer interconnection and communication is able to reduce or eliminate any impact on the performance of an integrated circuit caused by conductivity of a silicon substrate, reduce or eliminated cross-talk between channels (i.e., the coupling effect), and be capable of achieving interconnection speeds greater than 20 Gigabits per second (Gbps), in some embodiments.

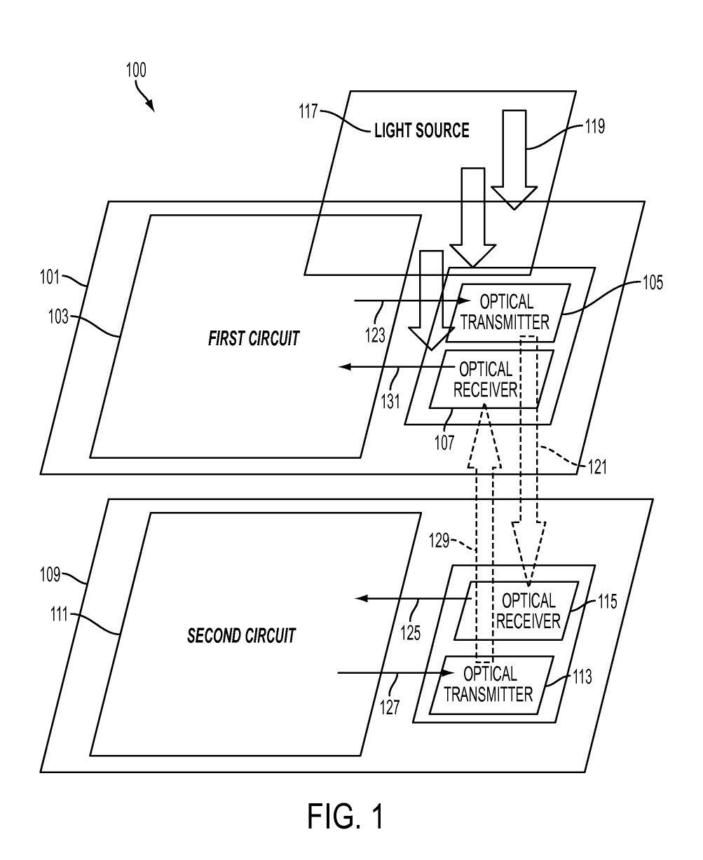

FIG. 1 is a diagram of a multi-layer integrated circuit 100 having two or more layers interconnected by way of via-less communication, in accordance with one or more embodiments.

The multi-layer integrated circuit 100 includes at least a first layer 101 comprising a first circuit 103, a first optical transmitter 105 coupled to the first circuit 103, and a first optical receiver 107 coupled to the first circuit 103. The multi-layer integrated circuit 100 also comprises a second layer 109 below the first layer 101. The second layer 109 comprises a second circuit 111, a second optical transmitter 113 coupled to the second circuit 111, and a second optical receiver 115 coupled to the second circuit 111. The second optical transmitter 113 is at least partially aligned with the first optical receiver 107, and the second optical receiver 115 is at least partially aligned with the first optical transmitter 105. The multi-layer integrated circuit 100 further comprises a light source 117 configured to input source light 119 to the first optical transmitter 105.

The first optical transmitter 105 is configured to modify the source light 119 and to output a first modulated light 121, based on first data 123 received from the first circuit 103, to the second optical receiver 115. The first modulated light 121 indicates a first data set 125. The second optical receiver 115 is configured to receive the first modulated light 121, convert the first modulated light 121 to the first data set 125, and communicate the first data set 125 to the second circuit 111. The second optical transmitter 113 is configured to receive the first modulated light 121 from the second optical receiver 115, modify the first modulated light 121 based on second data 127 received from the second circuit 111, and to output a second modulated light 129 to the first optical receiver 107. The second modulated light 129 indicates a second data set 131. The first optical receiver 107 is configured to receive the second modulated light 129, convert the second modulated light 129 to the second data set 131, and communicate the second data set 131 to the first circuit 103.

In some embodiments, the light source 117 is a laser light source external to the first layer 101 and the second layer 109. In some embodiments, the light source 117 is configured to inject source light 119 into the first layer 101 from a position above the first layer 101 using vertical cavity laser arrays. In other embodiments, the light source 117 is configured to inject source light 119 into the first layer 101 from a position above the first layer 101 using fiber arrays with lens couplers. Alternatively, or in addition to, injecting source light 119 from above the first layer 101, in some embodiments, the light source 117 is configured to inject source light 119 into the second layer 109 from a position below the second layer 109. In further embodiments, the light source 117 is configured to inject source light 119 into the first layer 101 and/or the second layer 109 from a direction including at least one side of the first layer 101 and/or the second layer 109.

In some embodiments, the first circuit 103 comprises a memory and the second circuit 111 comprises a processor. In other embodiments, the first circuit 103 comprises a processor and the second circuit 111 comprises a memory. In some embodiments, both the first circuit 103 and the second circuit 111 comprise memories. In other embodiments, both the first circuit 103 and the second circuit 111 comprise processors.

In one or more embodiments, the multi-layer integrated circuit 100 comprises a greater number of layers than the exemplary first layer 101 and second layer 109. For example, in some embodiments, a plurality of second layers 109 are provided below the first layer 101. In embodiments having more than the exemplary first layer 101 and second layer 109, the multi-layer integrated circuit 100 comprises any combination of memories and processors among the first layer 101 and the plurality of second layers 109.

The processors and/or memories that make up the first circuit 103 and/or the second circuit 111 are incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the multi-layer integrated circuit 100 is implemented in a single chip. It is further contemplated that in certain embodiments the multi-layer integrated circuit 100 is implemented as a single “system on a chip.” It is further contemplated that in certain embodiments a separate ASIC would not be used, for example, and that all relevant functions as disclosed herein would be performed by a processor or processors, e.g., first circuit 103 and/or second circuit 109. Multi-layer integrated circuit 101, or a portion thereof, constitutes a mechanism for performing one or more steps of via-less inter-layer communication.

In one or more embodiments, the first circuit 103 and/or the second circuit 109, comprise a single processor (or multiple processors) that performs a set of operations on information as specified by computer program code related to via-less inter-layer communication. The computer program code is a set of instructions or statements providing instructions for the operation of the processor and/or the computer system to perform specified functions.

The first circuit 103 and/or the second circuit 109, if embodied as a memory includes one or more of dynamic memory (e.g., RAM, magnetic disk, writable optical disk, etc.) and static memory (e.g., ROM, etc.) for storing executable instructions that when executed perform the steps described herein to provide via-less inter-layer communication. The memory also stores the data associated with or generated by the execution of various steps related to via-less inter-layer communication.

In one or more embodiments, if the first circuit and/or the second circuit are embodied as memory, such as a random access memory (RAM) or any other dynamic storage device, the memory stores information including processor instructions for via-less inter-layer communication. Dynamic memory allows information stored therein to be changed. RAM allows a unit of information stored at a location called a memory address to be stored and retrieved independently of information at neighboring addresses. The memory is also used by a processor to store temporary values during execution of processor instructions. In various embodiments, the memory is a read only memory (ROM) or any other static storage device that is not changed. Some memory is composed of volatile storage that loses the information stored thereon when power is lost. In some embodiments, the memory is a non-volatile (persistent) storage device that persists even when the multi-layer integrated circuit 100 is turned off or otherwise loses power.

The term “computer-readable medium” as used herein refers to any medium that participates in providing information to a processor, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, or another medium from which a computer can read. The term computer-readable storage medium is used herein to refer to a computer-readable medium.

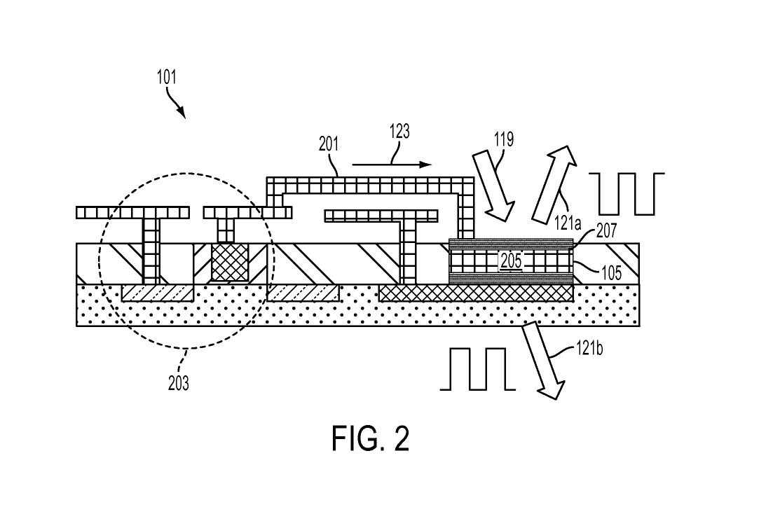

FIG. 2 is a diagram of the first layer 101 of the multi-layer integrated circuit 100 (FIG. 1) having an optical transmitter that comprises a surface normal resonant modulator, in accordance with one or more embodiments.

The first layer 101 comprises at least one redistribution layer 201 configured to couple the first optical transmitter 105 to the first circuit 103 (FIG. 1) by way of a first transistor 203 that enables the first circuit 103 to communicate first data 123 to the first optical transmitter 105. In some embodiments, the first optical transmitter 105 comprises a surface normal resonant modulator 205.

In some embodiments, light source 117 (FIG. 1) is configured to provide the source light 119 at an incident angle other than 90° with respect to a receptor surface of the first optical transmitter 105. The first modulated light 121 (FIG. 1) is output from the first optical transmitter 105 at an angle greater than about 0° and less than about 90° from one or more surfaces of the first optical transmitter 105 as one or more of first modulated light 121a or first modulated light 121b.

In some embodiments, the first layer 101 and the second layer 109 (FIG. 1) comprise a same type of optical transmitter. In other embodiments, the first layer 101 and the second layer 109 comprise differing types of optical transmitters. Accordingly, if the second layer 109 includes a second optical transmitter 113 (FIG. 1) that comprises a surface normal resonant modulator 205, the second optical transmitter 113 has similar properties to those discussed with respect to the first optical transmitter 105. For example, if the second optical transmitter 113 comprises a surface normal resonant modulator 205, the first modulated light 121 received by the second optical receiver 115 (FIG. 1) is communicated to the second optical transmitter 113 such that the first modulated light 121 has an incident angle other than 90° with respect to a receptor surface of the second optical transmitter 113. The second optical transmitter 113 is configured to output the second modulated light 129 (FIG. 1) an angle greater than about 0° and less than about 90° from one or more surfaces of the second optical transmitter 113. Also, the second optical transmitter 113 is configured to communicate with the second circuit 111 (FIG. 1) by way of another redistribution layer in the second layer 109 and another transistor in the second layer 109.

In some embodiments, the surface normal resonant modulator 205 comprises any combination of Si, Ge, Sn, III-V materials, or other suitable materials, which are one or more of a part of a substrate upon which the first layer 101 and/or the second layer 109, epitaxially grown, or wafer-level bonded. In one or more embodiments, the surface normal resonant modulator 205 comprises one or more cavity minors 207 configured to reflect an incident light such as source light 119 or first modulated light 121 and output light such as first modulated light 121 or second modulated light 129 at an angle between about 0° and less than about 90°. In some embodiments, the one or more cavity mirrors 207 comprise one or more layers of dielectrics, such as high-k, low-k, SiOx, SiNx, amorphous Si, or other suitable materials.

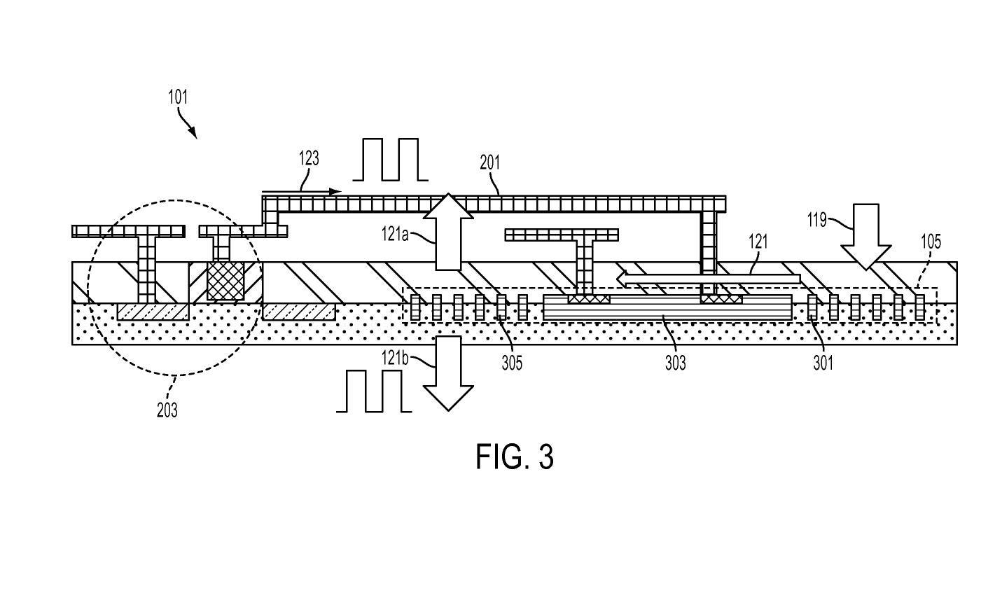

FIG. 3 is a diagram of the first layer 101 of the multi-layer integrated circuit 100 (FIG. 1) having an optical transmitter that comprises a grating coupler, in accordance with one or more embodiments.

The first layer 101 comprises at least one redistribution layer 201 configured to couple the first optical transmitter 105 to the first circuit 103 by way of transistor 203 that enables the first circuit 103 (FIG. 1) to communicate first data 123 to the first optical transmitter 105. According to various embodiments, the first optical transmitter 105 comprises a first grating coupler 301.

In some embodiments, light source 117 (FIG. 1) is configured to provide the source light 119 at an incident angle of 90° with respect to a receptor of the first grating coupler 301. In other embodiments, the light source 117 is configured to provide the source light 119 at an angle other than of 90° with respect to the receptor of the first grating coupler 301. The source light 119 is communicated downstream though a waveguide modulator 303 that generates the first modulated light 121 based on first data 123 received from the first circuit 103 by way of the redistribution layer 201. The first modulated light 121 is communicated downstream from the waveguide modulator 303 to a second grating coupler 305. The first modulated light 121 is output from the second grating coupler 305 normal to one or more surfaces of the second grating coupler 305 as one or more of first modulated light 121a or first modulated light 121b. In other embodiments, the first modulated light 121 is output from the second grating coupler 305 an angle other than of 90° with respect to one or more surfaces of the second grating coupler 305.

In some embodiments, the first layer 101 and the second layer 109 (FIG. 1) comprise a same type of optical transmitter. In other embodiments, the first layer 101 and the second layer 109 comprise differing types of optical transmitters. Accordingly, if the second layer 109 includes a second optical transmitter 113 (FIG. 1) that comprises a first grating coupler 301, a waveguide modulator 303, and a second grating coupler 305, the second optical transmitter 113 has similar properties to those discussed with respect to the first optical transmitter 105. For example, if the second optical transmitter 113 comprises a first grating coupler 301, a waveguide modulator 303, and second grating coupler 305, the first modulated light 121 received by the second optical receiver 115 (FIG. 1) is communicated to the second optical transmitter 113 such that the first modulated light 121 has an incident angle of 90° with respect to a receptor of a first grating coupler 301 of the second optical transmitter 113. The second optical transmitter 113, accordingly is configured to output the second modulated light 129 (FIG. 1) at an angle normal to one or more surfaces of a second grating coupler 305 of the second optical transmitter 113. Also, the second optical transmitter 113 is configured to communicate with the second circuit 111 (FIG. 1) by way of another redistribution layer in the second layer 109 and another transistor in the second layer 109.

In some embodiments, the first grating coupler 301, the waveguide modulator 303 and/or the second grating coupler 305 comprises a periodic structure of CMOS-compatible metals, high-k materials, or any other suitable material. In some embodiments, the waveguide modulator 303 comprises a dielectric waveguide. The dielectric waveguide, in some embodiments, comprises a patterned SiNx, amorphous Si, a high-k material, or other suitable material surrounded by SiOx, a low-k material, or other suitable material. In other embodiments, the waveguide modulator 303 comprises a plasmonic waveguide structure that comprises patterned metal nanowires surrounded by dielectrics materials.

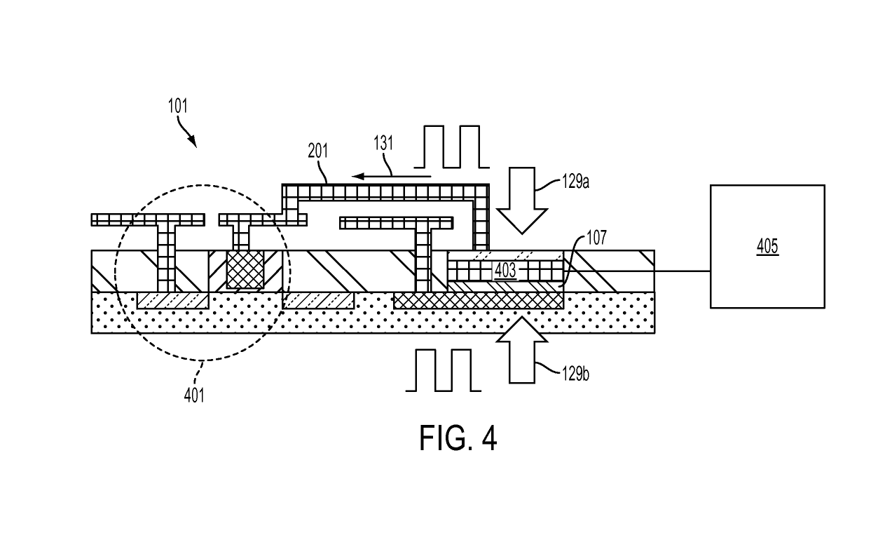

FIG. 4 is a diagram of the first layer 101 of the multi-layer integrated circuit 100 (FIG. 1) having an optical receiver that comprises a photodiode, in accordance with one or more embodiments.

The first layer 101 comprises at least one redistribution layer 201 configured to couple the first optical receiver 107 to the first circuit 103 by way of a second transistor 401 that enables the first circuit 103 (FIG. 1) to receive second data set 131 from the first optical receiver 107. According to various embodiments, the first optical receiver comprises a photodiode 403. The multi-layer integrated circuit 100 one of comprises, or is in communication with, a bias circuit 405 configured to facilitate conversion of the received second modulated light 129 to a voltage by the photodiode 403.

In some embodiments, the first optical receiver 107 is configured to receive second modulated light 129 (FIG. 1) as one or more of second modulated light 129a or second modulated light 129b output by the second optical transmitter 113 (FIG. 1) at an angle other than 90° with respect to a surface of the second optical transmitter 113. In other embodiments, the first optical receiver 107 is configured to receive the second modulated light 129 output by the second optical transmitter 113 normal to a surface of the second optical transmitter 113.

In some embodiments, the first layer 101 and the second layer 109 (FIG. 1) comprise a same type of optical receiver. In other embodiments, the first layer 101 and the second layer 109 comprise differing types of optical receivers. Accordingly, if the second layer 109 includes a second optical receiver 115 (FIG. 1) that comprises a photodiode 403, the second optical receiver 115 has similar properties to those discussed with respect to the first optical receiver 107. For example, if the second optical receiver 115 comprises a photodiode 403, the second optical receiver 115 is configured to receive first modulated light 121 output by the first optical transmitter 105 (FIG. 1) at an angle other than 90° with respect to a surface of the first optical transmitter 105. In other embodiments, the second optical receiver 115 is configured to receive the first modulated light 121 output by the first optical transmitter 105 normal to a surface of the first optical transmitter 105. Also, the second optical receiver 115 is configured to communicate with the second circuit 111 (FIG. 1) by way of another redistribution layer in the second layer 109 and another transistor in the second layer 109.

In some embodiments, the photodiode 403 comprises any combination of Si, Ge, Sn, III-V materials, or other suitable materials, which one or more of part of a substrate upon which the first layer 101 and/or the second layer 109, epitaxially grown or wafer-level bonded.

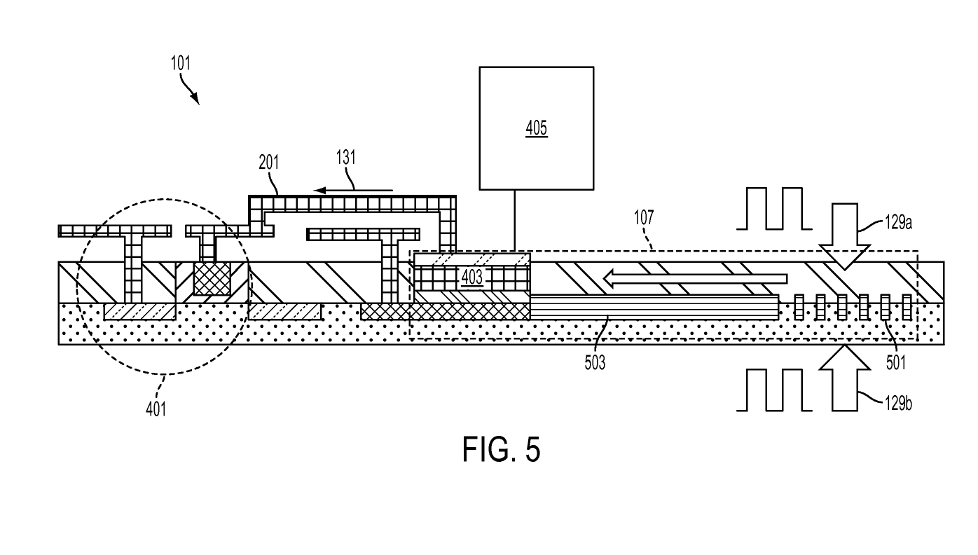

FIG. 5 is a diagram of the first layer 101 of the multi-layer integrated circuit 100 (FIG. 1) having an optical receiver that comprises a photodiode and a grating coupler, in accordance with one or more embodiments.

The first layer 101 comprises at least one redistribution layer 201 configured to couple the first optical receiver 107 to the first circuit 103 (FIG. 1) by way of second transistor 401 that enables the first circuit 103 to receive second data set 131 from the first optical receiver 107. The first optical receiver 107 comprises photodiode 403. The multi-layer integrated circuit 100 one of comprises, or is in communication with, a bias circuit 405 configured to facilitate conversion of the received second modulated light 129 to a voltage by the photodiode 403. The first layer 101 also comprises an optical receptor grating coupler 501.

In some embodiments, the first optical receiver 107 is configured to receive second modulated light 129 (FIG. 1) as one or more of second modulated light 129a or second modulated light 129b output by the second optical transmitter 113 (FIG. 1) by way of the optical receptor grating coupler 501. The second modulated light 129 is communicated downstream though an optical receptor waveguide modulator 503 to the photodiode 403 to generate second data set 131.

In some embodiments, the first layer 101 and the second layer 109 (FIG. 1) comprise a same type of optical receiver. In other embodiments, the first layer 101 and the second layer 109 comprise differing types of optical receivers. Accordingly, if the second layer 109 includes a second optical receiver 115 that comprises a photodiode 403, the second optical receiver 115 has similar properties to those discussed with respect to the first optical receiver 107. For example, if the second optical receiver 115 comprises a photodiode 403, an optical receptor grating coupler 501, and an optical receptor waveguide modulator 503, the second optical receiver 115 is configured to receive first modulated light 121 (FIG. 1) output by the first optical transmitter 105 (FIG. 1) by way of a second layer optical receptor grating coupler 501. The first modulated light 121 is communicated downstream though a second layer optical receptor waveguide modulator 503 to the photodiode 403 of the second layer 109 to generate first data set 125 (FIG. 1) for communication to the second circuit 111 (FIG. 1).

In some embodiments, the optical receptor grating coupler 501 and/or the optical receptor waveguide modulator 503 comprise a periodic structure of CMOS-compatible metals, high-k materials, or any other suitable material. In some embodiments, the optical receptor waveguide modulator 503 comprises a dielectric waveguide. The dielectric waveguide, in some embodiments, comprises a patterned SiNx, amorphous Si, a high-k material, or other suitable material surrounded by SiOx, a low-k material, or other suitable material. In other embodiments, the optical receptor waveguide modulator 503 comprises a plasmonic waveguide structure comprises patterned metal nanowires surrounded by dielectrics materials.

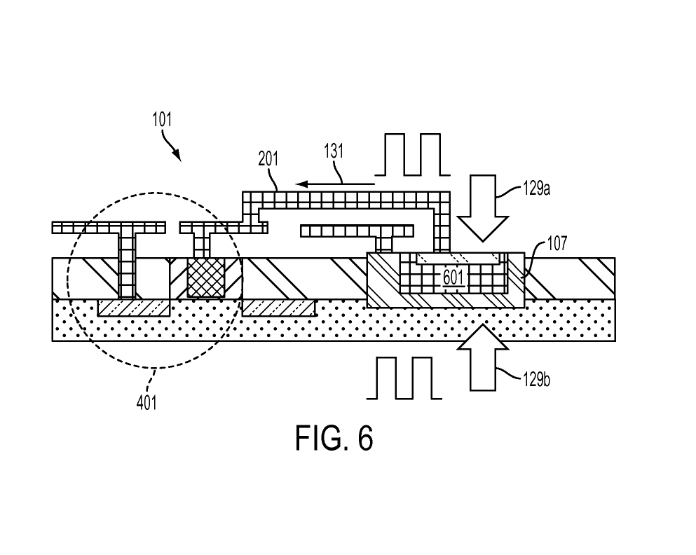

FIG. 6 is a diagram of the first layer 101 of the multi-layer integrated circuit 100 (FIG. 1) having an optical receiver that comprises a phototransistor, in accordance with one or more embodiments.

The first layer 101 comprises at least one redistribution layer 201 configured to couple the first optical receiver 107 to the first circuit 103 (FIG. 1) by way of a second transistor 401 that enables the first circuit 103 to receive second data set 131 from the first optical receiver 107. According to various embodiments, the first optical receiver 107 comprises a phototransistor 601 configured to convert the received second modulated light 129 (FIG. 1), received as one or more of second modulated light 129a or second modulated light 129b, to a voltage and generate second data set 131.

In some embodiments, the first layer 101 and the second layer 109 (FIG. 1) comprise a same type of optical receiver. In other embodiments, the first layer 101 and the second layer 109 comprise differing types of optical receivers. Accordingly, if the second layer 109 includes a second optical receiver 115 (FIG. 1) that comprises a phototransistor 601, the second optical receiver 115 has similar properties to those discussed with respect to the first optical receiver 107. For example, if the second optical receiver 115 comprises a phototransistor 601, the second optical receiver 115 is configured to convert the received first modulated light 121 to a voltage and generate first data set 125 (FIG. 1).

In some embodiments, the phototransistor 601 comprises any combination of Si, Ge, Sn, III-V materials, or other suitable materials, which one or more of part of a substrate upon which the first layer 101 and/or the second layer 109 lie, epitaxially grown or wafer-level bonded.

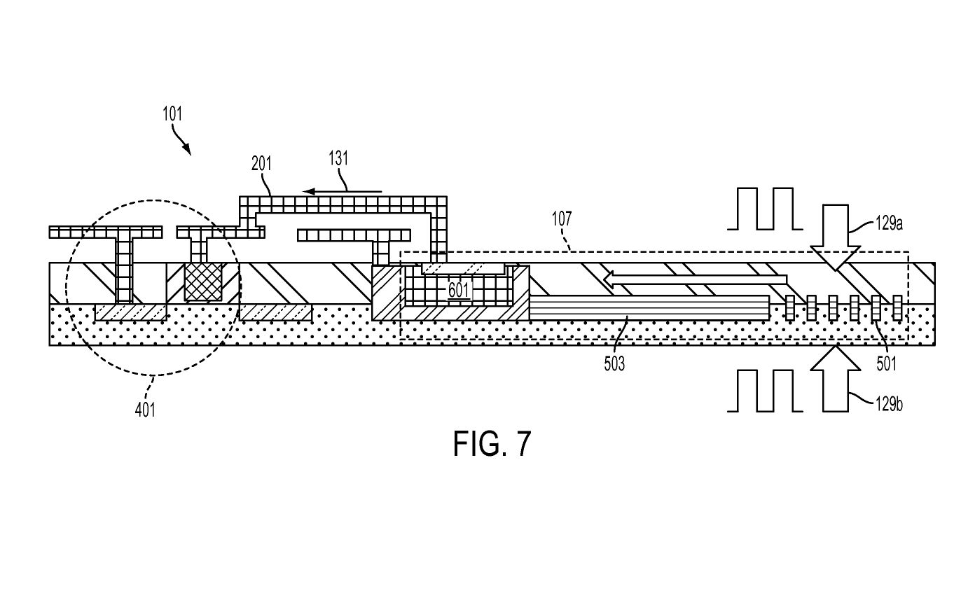

FIG. 7 is a diagram of the first layer 101 of the multi-layer integrated circuit 100 (FIG. 1) having an optical receiver that comprises a phototransistor and a grating coupler, in accordance with one or more embodiments.

The first layer 101 comprises at least one redistribution layer 201 configured to couple the first optical receiver 107 to the first circuit 103 (FIG. 1) by way of transistor 401 that enables the first circuit 103 to receive second data set 131 from the first optical receiver 107. According to various embodiments, the first optical receiver 107 comprises phototransistor 601 configured to convert the received second modulated light 129 (FIG. 1), received as one or more of second modulated light 129a or second modulated light 129b, to a voltage and generate second data set 131. The first layer 101 also comprises optical receptor grating coupler 501.

In some embodiments, the first optical receiver 107 is configured to receive second modulated light 129 output by the second optical transmitter 113 (FIG. 1) by way of the optical receptor grating coupler 501. The second modulated light 129 is communicated downstream though optical receptor waveguide modulator 503 to the phototransistor 601 to generate second data set 131.

In some embodiments, the first layer 101 and the second layer 109 (FIG. 1) comprise a same type of optical receiver. In other embodiments, the first layer 101 and the second layer 109 comprise differing types of optical receivers. Accordingly, if the second layer 109 includes a second optical receiver 115 (FIG. 1) that comprises a phototransistor 601, the second optical receiver 115 has similar properties to those discussed with respect to the first optical receiver 107. For example, if the second optical receiver 115 comprises a phototransistor 601, an optical receptor grating coupler 501 and an optical receptor waveguide modulator 503, the second optical receiver 115, accordingly is configured to receive first modulated light 121 (FIG. 1) output by the first optical transmitter 105 by way of a second layer optical receptor grating coupler 501. The first modulated light 121 is communicated downstream though a second layer optical receptor waveguide modulator 503 to the phototransistor 601 of the second layer 109 to generate first data set 125 (FIG. 1) for communication to the second circuit 111 (FIG. 1).

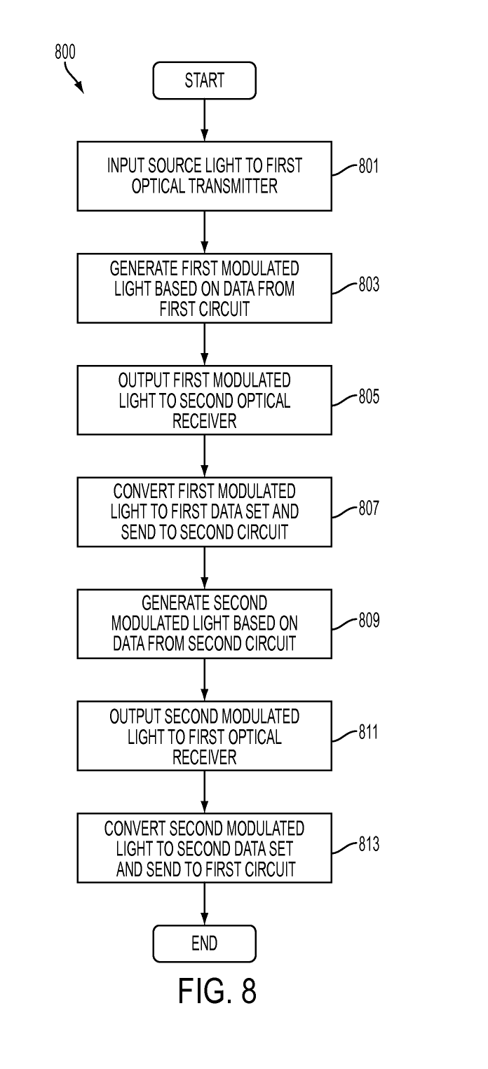

FIG. 8 is a flow chart of a method 800 of via-less communication in a multi-layer integrated circuit, in accordance with one or more embodiments. In step 801 a light source inputs a source light into a first layer of a multi-layer integrated circuit. The first layer comprises a first circuit, a first optical transmitter coupled to the first circuit, and a first optical receiver coupled to the first circuit, the source light being input into the first optical transmitter.

In step 803, the first optical transmitter generates a first modulated light indicative of a first data set. The first modulated light is generated by modifying the source light based on data received from the first circuit.

In step 805, the first optical transmitter outputs the first modulated light to a second layer. The second layer comprises a second circuit, a second optical transmitter coupled to the second circuit and at least partially aligned with the first optical receiver. The second layer also comprises a second optical receiver coupled to the second circuit and at least partially aligned with the first optical transmitter. The second optical receiver is configured to receive the first modulated light.

In step 807, the second optical receiver converts the received first modulated light to a voltage generating the first data set and communicates the first data set from the second optical receiver to the second circuit.

In step 809, the second optical transmitter generates a second modulated light indicative of a second data set by modifying the first modulated light based on data received from the second circuit.

In step 811, the second optical transmitter outputs the second modulated light to the first optical receiver. In step 813, the first optical receiver converts the second modulated light to a voltage generating the second data set and communicates the second data set to the first circuit.

One aspect of this description relates to a multi-layer integrated circuit comprising a first layer comprising a first circuit, a first optical transmitter coupled to the first circuit, and a first optical receiver coupled to the first circuit. The multi-layer integrated circuit also comprises a second layer below the first layer, the second layer comprising a second circuit, a second optical transmitter coupled to the second circuit, the second optical transmitter being at least partially aligned with the first optical receiver, and a second optical receiver coupled to the second circuit, the second optical receiver being at least partially aligned with the first optical transmitter. The multi-layer integrated circuit further comprises a light source configured to input source light to the first optical transmitter.

The first optical transmitter is configured to modify the source light and to output a first modulated light based on data received from the first circuit to the second optical receiver. The first modulated light indicates a first data set, the second optical receiver is configured to receive the first modulated light and communicate the first data set to the second circuit.

Another aspect of this description relates to a method comprising inputting a source light from a light source into a first layer of a multi-layer integrated circuit, the first layer comprising a first circuit, a first optical transmitter coupled to the first circuit, a first optical receiver coupled to the first circuit, the source light being input into the first optical transmitter. The method also comprising generating a first modulated light indicative of a first data set by the first optical transmitter, the first modulated light being generated by modifying the source light based on data received from the first circuit. The method further comprises outputting the first modulated light from the first optical transmitter to a second layer comprising a second circuit, a second optical transmitter coupled to the second circuit, the second optical transmitter being at least partially aligned with the first optical receiver, and a second optical receiver coupled to the second circuit, the second optical receiver being at least partially aligned with the first optical transmitter and configured to receive the first modulated light. The method additionally comprises communicating the first data set from the second optical receiver to the second circuit.

Still another aspect of this description relates to an integrated circuit comprising a first layer comprising a memory, a first optical transmitter coupled to the memory, and a first optical receiver coupled to the memory. The integrated circuit also comprises a second layer comprising a processor, a second optical transmitter coupled to the processor, the second optical transmitter being at least partially aligned with the first optical receive, and a second optical receiver coupled to the processor, the second optical receiver being at least partially aligned with the first optical transmitter. The integrated circuit further comprises a light source configured to input source light to one of the first optical transmitter or the second optical transmitter.

The first optical transmitter is configured to modify the source light or light received by the first optical receiver from the second optical transmitter based on data received from the memory and output a first modulated light to the second optical receiver. The first modulated light indicates a first data set, the second optical receiver is configured to receive the first modulated light and communicate the first data set to the processor.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. Although features of various embodiments are expressed in certain combinations among the claims, it is contemplated that these features can be arranged in any combination and order. It is therefore intended that the protection granted hereon be limited only by the definition contained in the appended claims and equivalents thereof.

What is claimed is:

1. A multi-layer integrated circuit comprising:
a first layer comprising:
a first circuit;
a first optical transmitter coupled to the first circuit; and
a first optical receiver coupled to the first circuit;
a second layer below the first layer, the second layer comprising:
a second circuit;
a second optical transmitter coupled to the second circuit, the second optical transmitter being at least partially aligned with the first optical receiver; and
a second optical receiver coupled to the second circuit, the second optical receiver being at least partially aligned with the first optical transmitter; and
a light source configured to input source light to the first optical transmitter,
wherein the first optical transmitter is configured to modify the source light and to output a first modulated light based on data received from the first circuit to the second optical receiver, the first modulated light indicates a first data set, the second optical receiver is configured to receive the first modulated light and communicate the first data set to the second circuit.

2. The multi-layer integrated circuit of claim 1, wherein the second optical transmitter is configured to modify the first modulated light based on data received from the second circuit and to output a second modulated light to the first optical receiver, the second modulated light indicates a second data set, and the first optical receiver is configured to receive the second modulated light and communicate the second data set to the first circuit.

3. The multi-layer integrated circuit of claim 1, wherein one or more of the first optical transmitter and the second optical transmitter comprise a surface normal resonant modulator.

4. The multi-layer integrated circuit of claim 3, wherein the light source is configured to provide the source light at an incident angle other than 90°, and the first modulated light is output from the first optical transmitter at an angle greater than about 0° and less than about 90° from one or more surfaces of the second optical transmitter.

5. The multi-layer integrated circuit of claim 1, wherein one or more of the first optical transmitter and the second optical transmitter comprise a grating coupler.

6. The multi-layer integrated circuit of claim 5, wherein the light source is configured to provide the source light at an incident angle of 90°, the source light is communicated downstream from the grating coupler to another grating coupler, the first modulated light is output downstream from another grating coupler normal to one of more surfaces of the another grating coupler.

7. The multi-layer integrated circuit of claim 1, wherein one or more of the first optical receiver and the second optical receiver comprise a photodiode, and the multi-layer integrated circuit further comprises:
a current supply configured to facilitate conversion of the received first modulated light or a received second modulated light to a voltage.

8. The multi-layer integrated circuit of claim 7, further comprising:
a modulated light grating coupler coupled to the photodiode, the modulated light grating coupler being configured to receive the first modulated light or the second modulated light and communicate the received modulated light downstream to the photodiode.

9. The multi-layer integrated circuit of claim 1, wherein one or more of the first optical receiver and the second optical receiver comprise a phototransistor configured to receive the first modulated light or a second modulated light and convert the received first modulated light or the received second modulated light to a voltage.

10. The multi-layer integrated circuit of claim 9, further comprising:
a modulated light grating coupler coupled to the phototransistor, the modulated light grating coupler being configured to receive the first modulated light or the second modulated light and communicate the received modulated light downstream to the phototransistor.

11. A method comprising:
generating a first modulated light indicative of a first data set by a first optical transmitter in a first layer of a multi-layer integrated circuit, the first modulated light being generated by modifying a received source light based on data received from a first circuit in the first layer;
outputting the first modulated light from the first optical transmitter to a second layer comprising:
a second circuit;
a second optical transmitter coupled to the second circuit, the second optical transmitter being at least partially aligned with the first optical receiver; and
a second optical receiver coupled to the second circuit, the second optical receiver being at least partially aligned with the first optical transmitter and configured to receive the first modulated light;
communicating the first data set from the second optical receiver to the second circuit.

12. The method of claim 11, further comprising:
generating a second modulated light indicative of a second data set by the second optical transmitter, the second modulated light being generated by modifying the first modulated light based on data received from the second circuit;
outputting the second modulated light from the second optical transmitter to the first optical receiver; and
communicating the second data set from the first optical receiver to the first circuit.

13. The method of claim 11, wherein one or more of the first optical transmitter and the second optical transmitter comprise a surface normal resonant modulator.

14. The method of claim 13, further comprising:
outputting the source light source at an incident angle other than 90°; and
outputting the first modulated light from the first optical transmitter at an angle greater than about 0° and less than about 90° from one or more surfaces of the first optical transmitter.

15. The method of claim 11, wherein one or more of the first optical transmitter and the second optical transmitter comprise a grating coupler.

16. The method of claim 15, further comprising:
outputting the source light at an incident angle of 90°;
communicating the source light downstream from the grating coupler to another grating coupler; and
outputting the first modulated light normal to one of more surfaces of the another grating coupler.

17. The method of claim 11, wherein one or more of the first optical receiver and the second optical receiver comprise a photodiode, the method further comprising:
supplying a current by a current supply source to the photodiode; and
converting the received first modulated light or a received second modulated light to a voltage.

18. The method of claim 11, wherein one or more of the first optical receiver and the second optical receiver comprise a phototransistor configured to receive the first modulated light or a second modulated light, the method further comprising:
converting the received first modulated light or the received second modulated light to a voltage by the phototransistor.

19. An integrated circuit comprising:
a first layer comprising:
a memory;
a first optical transmitter coupled to the memory; and
a first optical receiver coupled to the memory;
a second layer comprising:
a processor;
a second optical transmitter coupled to the processor, the second optical transmitter being at least partially aligned with the first optical receiver; and
a second optical receiver coupled to the processor, the second optical receiver being at least partially aligned with the first optical transmitter; and
a light source configured to input source light to one of the first optical transmitter or the second optical transmitter,
wherein
the first optical transmitter is configured to modify the source light or light received by the first optical receiver from the second optical transmitter based on data received from the memory and output a first modulated light to the second optical receiver, the first modulated light indicates a first data set, the second optical receiver is configured to receive the first modulated light and communicate the first data set to the processor.

20. The multi-layer integrated circuit of claim 19, wherein the second optical transmitter is configured to modify the first modulated light or the source light based on data received from the processor and output a second modulated light to the first optical receiver, the second modulated light indicates a second data set, and the first optical receiver is configured to receive the second modulated light and communicate the second data set to the memory.
